(19) United States
(12) Patent Application Publication
(10) Pub. No.: US 2017/0182749 A1
(43) Pub. Date: Jun. 29, 2017

(54) SUBSTRATE CERAMIC LAMINATE

(71) Applicant: Ceram Tec-ETEC GmbH, Lohmar (DE)

(72) Inventors: Lars SCHNETTER, Wimbach (DE); Helen MENGES, Rheinbach (DE); Dieter EFFENBERGER, Köln (DE); Benedikt HAVERMANN, Siegburg (DE); Matthias SWERBINKA, Alfter (DE); Dimitri KUDRJASHOV, Hennef (DE); Katharina BAUR, Köln (DE); Mandy WEICHOLD, Sankt Augustin (DE)

(21) Appl. No.: 15/117,051

(22) PCT Filed: Feb. 5, 2015
(86) PCT No.: PCT/EP2015/052438

§ 371 Date: Aug. 5, 2016

(30) Foreign Application Priority Data
Feb. 7, 2014 (DE) 10 2014 001 530.0

(51) Int. Cl. B32B 18/00; C04B 37/04; C04B 37/02; B32B 7/02; C04B 37/00

(52) U.S. Cl. CPC B32B 18/00; B32B 7/02; C04B 37/00; C04B 37/001; C04B 37/021; C04B 37/042; C04B 37/003; C04B 37/023; C04B 37/045; B32B 2307/412; B32B 2307/554; B32B 2307/584; B32B 2307/704; B32B 2315/02; B32B 2457/20; C04B 2237/343; C04B 2237/36; C04B 2237/348; C04B 2237/40; C04B 2237/30; C04B 2237/704

(57) ABSTRACT

The invention relates to substrate ceramic laminates. In particular, the invention relates to substrate ceramic laminates in which the ceramic layer is a functional layer.

The invention relates to substrate ceramic laminates. In particular, the invention relates to substrate ceramic laminates in which the ceramic layer is a functional layer.

In relation to the present invention, a “functional layer” is understood as being a layer which comprises a ceramic, particularly a polycrystalline ceramic, which has a function in relation to the overall component or the laminate composed of substrate and functional layer. This function is essentially not a carrier or stabilizing function. Such functions can be, for example, mechanical, e.g., scratch resistance, chemical, e.g., chemical resistance, or also thermal, e.g., thermal stability, or also optical, e.g., a filter effect. The list is not exhaustive and exclusively serves to exemplify the invention in more detail.

In principle, the invention involves the design of a mechanically, chemically or thermally resistant functional surface. A substrate is applied to a ceramic-comprising layer, hereinafter also only referred to as “ceramic layer”, the ceramic layer having a special function with respect to the component in which this laminate composed of substrate and ceramic-comprising layer is used, or with respect to the laminate as such. The ceramic-comprising layer is relatively thin, for which reason a bearing substrate material is used as a sensible reinforcement.

Alternative solutions are known from the prior art: These are chemically and thermally hardened thin glasses or sapphire glasses (the terms “sapphire crystal” or simply “sapphire” are synonymously used here) made from monocrystals. One more recent development is the application of very thin sapphire monocrystal layers to a glass substrate, that is, the manufacture of sapphire on glass (SOG) laminates. Another alternative consists in the application of especially hard layers such as, for example, DLC (diamond-like carbon) layers or the like to substrates.

Particularly when coating substrates with functional layers, for example by means of PVC (physical vapor deposition), CVD (chemical vapor deposition), sol gel coatings or the like, the problem arises, however, that the thickness of the individual layers and of the layer package is limited. For larger layer thicknesses, adhesive strengths between substrate and layer are no longer sufficient for some applications; the coating easily chips. Presumably also due to the small thickness, the layers are sensitive, especially as regards the durability of the adhesion between coating and substrate, but also with respect to scratch resistance.

While the alternatives made of hardened glass, “Gorilla Glass” by Coming or “Xensation” by Schott, for example, usually have high strengths of over 500 MPa, they have the drawback of not being sufficiently scratch-resistant and/or chemically and thermally resistant.

Sapphire is optically birefringent, and therefore it has drawbacks in some optical applications. As regards mechanical and thermal stability, sapphire is anisotropic. At high loads, a special design is necessary in order to subject the most suitable “side” or crystal face of the sapphire monocrystal to the direction of maximum load. One possible result of this is that very large monocrystals have to be cultivated in order to produce cuts in the “right direction”. This is another reason why sapphire is extremely expensive.

Moreover, sapphire has a Mohs hardness of 9 and is therefore very difficult to process. Cutting, grinding or polishing is only possible with diamond tools. It is therefore also difficult and expensive to process or manufacture sapphire substrates in more complex geometries.

The SOG laminates, usually a 0.56 mm-thick sapphire monocrystal layer on 3 to 6 mm-thick, chemically hardened glass, make it possible to produce more cost-effective, transparent wear-resistant layers. Nonetheless, the manufacturing costs are still quite high. What is more, the problem of birefringence remains, as do the difficulties associated in processing. The sapphire glass is generally cut out of a larger piece by means of diamond saws and must be polished on both sides. The expensive polishing also leads to high costs for this application.

The object of the invention consists in the provision of components with functional surfaces that can be manufactured more cost-effectively than corresponding components known from the prior art. Moreover, the components are preferably also to be at least partially transparent.

The object is achieved by the subject matter of claim 1; advantageous embodiments of the invention can be derived from the subclaims.

Subject matter according to the invention thus comprises a component with a functional surface. Especially preferably, the component comprises a substrate and a polycrystalline functional layer, the functional layer comprising or providing the functional surface,

An embodiment of the invention is preferred in which the functional layer comprises a ceramic, especially preferably a polycrystalline ceramic.

Depending on the intended use of the component according to the invention, a wide range of materials can be used for the substrate. For instance, plastics, glasses, glass ceramics or ceramics, but also composite materials and flexible materials can be used, this selection not being intended to constitute a limitation. For applications that require a transparent component, glasses, but also plastics are particularly suitable as substrate materials. For applications in which no transparency is desired or required, translucent or opaque materials can naturally also be used for the substrate.

In terms of the invention, a transparent ceramic is understood as being a ceramic having an RIT (real in-line transmission) of at least 40%, preferably of at least 60%, at 300 nm, 600 nm and/or 1500 nm light wavelength.

In order to eliminate scattered light from measurements, the transmission of the material is measured using a very narrow aperture angle of about 0.5° arid the measured value is then put in a ratio to the theoretically maximum transmission for this material. This then yields the determined RIT.

Theoretically speaking, transparency is thickness-independent when a perfect material is present and a perfect ceramic has been manufactured from it. However, as soon as the ceramic contains pores or the like, a scattering effect occurs at the phase boundaries of the pores, which increases as the thickness of the ceramic increases. This effect leads to decreasing transparency. In relation to this invention, the terms “transparency” and “RIT” refer to ceramics with thicknesses between 50 μm and 100 mm.

Depending on the application, the functional layers can also comprise transparent, translucent or opaque ceramics. Transparent ceramics are especially preferred as functional layers, because they combine substantial advantages of glasses and ceramics with each other. In principle, all transparent ceramics can be used, bᵤt particularly spinets and preferably Al—Mg spinel, ZrO₂, AlON, SiAlON—Al₂O₃— or mixed oxide ceramics from the system Y—Al—Mg—O. In conjunction with an also transparent substrate, these components can be used as alternatives to the very expensive sapphire monocrystal applications. In comparison to sapphire, functional layers made of ceramics offer various advantages:

Due to their monocrystalline structure, sapphire glasses are optically, mechanically and chemically anisotropic, i.e., they are optically birefringent and have preferred directions with respect to all other characteristics. As a result of their irregular structure, polycrystalline ceramics are substantially isotropic. In transparent ceramics whose minerals are cubic, this is also true with respect to optics; that is, there is no birefringence. Birefringence does exist in non-cubic, transparent ceramics, but because the grain size of the minerals must be less than 100 nm in order to produce transparency, the effect of birefringence is generally negligible in these polycrystalline materials.

Another advantage of ceramic, particularly of spinel ceramics, is the outstanding workability at a comparable hardness, compared to sapphire glasses. For example, if one uses a 0.5 to 2 mm-thick transparent ceramic (spinel) layer as a functional layer, a comparably scratch-resistant, chemically and thermally resistant layer, as in SOG composites, can be produced. Since the processing time (polishing to a predetermined surface quality) of a spinel ceramic only takes about 1/4 of the time required for the same processing of a sapphire glass, the processing time is shortened substantially, which leads to substantially lower costs.

The surprising finding that (spinel) ceramics have substantially better workability than sapphire glasses even though both have the same Mohs hardness can likely be attributed to the polycrystalline structure of the ceramic. It is assumed that individual crystals are broken out of the structure of the ceramic as a result of processing. The breaking-out of crystals appears to be more readily possible than the processing of the crystal structure as such.

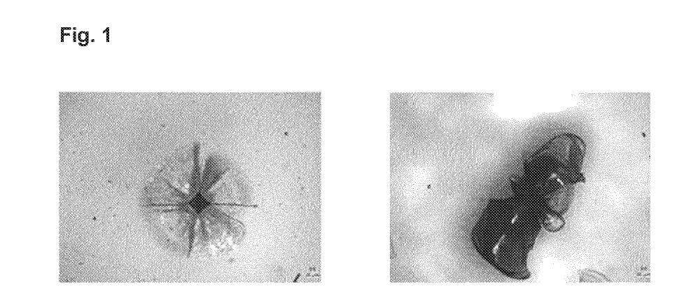

Another advantage of ceramics, particularly of spinel ceramics, is a higher “micro-scale damage tolerance” compared to a sapphire glass of equal thickness; see FIG. 1. This figure shows a transparent spinel ceramic in the left image and a sapphire glass in the right image. Both materials underwent a Vickers hardness test which resulted in damage. The damage in the spinel ceramic corresponds substantially to the imprint of the Vickers indenter, whereas the damage in the sapphire glass has extended farther into the surroundings as a result of chipping.

Moreover, polycrystalline ceramics are more readily dopable than sapphire glasses. The doping can be performed to produce optical band filters and colorations, particularly in transparent functional layers. The doping can be up to 5 wt. % of the starting material. Doping elements worthy of consideration are elements from the series of the lanthanides, actinides, as well as Fe, Cr, Co, Cu and other known doping elements.

Other functions that can be produced with functional layers according to the invention are generally mechanical, chemical or thermal resistances or the optical functions already described above. In particular, an antireflective, scratch-resistant and/or anti-fog effect can be achieved, it also being possible, depending on the material, for several functions to be achieved with the same material.

According to an especially preferred embodiment of the invention, the substrate and the functional layer are joined together by means of an adhesion promoter, the adhesion promoter preferably being an adhesive.

If the component is to be transparent, a transparent adhesive can be used as an adhesion promotor, for example, whose refractive index lies between the refractive index of the substrate and of the functional layer.

Another advantage in using an adhesion promotor between substrate anti functional layer is that the functional layer need only be polished on its upper side, i.e., on the side of the functional layer which side faces away from the substrate, if an adhesion promotor with an appropriate refractive index was selected. The refractive index of the adhesion promotor should then be very similar to the refractive index of the functional layer, so that no perceivable phase transition or perceivable boundary surface is produced for the intended use.

In order to reduce costs and combine positive characteristics of different materials, very thin ceramic layers (<2 mm, better <0.5 mm, especially preferably 100 μm) can be laminated with other transparent materials, particularly glass.

If the functional layer has a thickness of less than 100 μm, it is flexible. This offers the advantage that bent substrates can be provided with such a layer without difficulty, since the functional layer can adapt to the bent shape of the substrate, That is advantageous, for example, in windshields or watch glasses and really in all non-planar substrates. Flexible materials such as plastics can of course also be provided with these functional layers.

What is more, if an adhesion promotor is used whose refractive index is adapted, then it is possible, for example, to apply an extremely thin (<500 μm or even <100 μm) thick transparent ceramic layer to a chemically hardened glass substrate without polishing the side of the ceramic layer that is in contact with the glass substrate or the adhesion promotor. The adhesion promotor, for example an adhesive, optically levels out the unevenness of the surface, since it has substantially the same refractive index as the ceramic. Then only the surface of the overall component needs to be polished. In this way, it is possible to polish very thin layers, e.g., layers less than 100 μm thick.

It is therefore only necessary to polish the ceramic on the upper side of the component. That is more cost-effective, not least because two-sided polishing is rendered unnecessary. Compared to a sapphire glass, for example, a spinel ceramic can be polished in order to obtain the same surface quality in ¼ of the time. If polishing is additionally only required on one side of the functional layer instead of on both sides, ¾ of the time that would be required for obtaining the surface quantity of a comparable sapphire functional layer can be saved.

If the component does not need to be transparent, it is of course also possible to polish only one side of the functional layer or to leave the functional layer generally unpolished. The use of an adhesive with an adapted refractive index is then of course superfluous.

Specific applications for components according to the invention are scanner surfaces, for example of scanner cash registers, surfaces of blasting cabinets, as well as all transparent surfaces that are subject to wear, such as floor coverings, stairs or also watch glasses, for example.

Through a combination of very thin, chemically hardened glass, for example in a thickness from 0.3 to 5 mm, with an even thinner polycrystalline, transparent ceramic, for example with a thickness from 0.02 to 0.8 mm, extremely durable thin optical components can be produced which, for example, are outstandingly suitable for displays of mobile phones, tablets, computers in general, etc. By virtue of the substantially thinner ceramic layer, the scratch resistance of the ceramic as well as the other described characteristics can be exploited, and the greatest disadvantage of ceramics—that of insufficient strengths in the case of small component thicknesses, such as 200 to 300 MPa, for example—can be compensated by the chemically hardened glass. This system also offers the special advantage of being substantially cheaper than the SOG laminates.

Another aspect of the invention is the possibility of configuring larger, particularly transparent surfaces. Through the use of an adhesion promotor having an adapted refractive index, a large surface can be configured from many smaller tiles (multi-tile) that are embedded next to each other in the adhesion promotor, for example. In this way, flat displays can be created for large televisions, for example, that cannot be produced with sapphire glasses due to the monocrystal limitation.

The present invention therefore comprises particularly:
Components with functional surface.
Components, the component comprising a substrate and a polycrystalline functional layer, and the functional layer comprising the functional surface.
Components according to one of the preceding points, the polycrystalline functional layer comprising a ceramic.
Components according to one of the preceding points, the substrate comprising a plastic, a glass, a glass ceramic or a ceramic or a composite material or a flexible material.
Components according to one of the preceding points, the functional layer having a thickness of less than 2 mm, preferably less than 0.5 mm and especially preferably less than 100 μm.
Components according to one of the preceding points, the substrate and/or the functional layer being transparent.
Components according to one of the preceding points, the functional layer being mechanically and/or chemically and/or thermally stable.
Components according to one of the preceding points, the functional layer having an optical function, particularly an antireflective effect and/or a filter effect.
Components according to one of the preceding points, the functional layer having a scratch-resistant and/or an anti-fog effect.
Components according to one of the preceding points, the substrate and the functional layer being connected to each other by means of an adhesion promotor.
Components according to one of the preceding points, the adhesion promotor being transparent and having a refractive index which lies between the refractive index of the substrate and of the functional layer, or a transparent adhesion promotor which has the same refractive index as the functional layer.
Components according to one of the preceding points, the functional layer being polished only on one side which is facing away from the substrate,
Components according to one of the preceding points, the functional layer comprising a transparent ceramic, particularly an Al—Mg spinel, an Al₂O₃, an AlON, an SiAlON, ZrO₂ or a mixed oxide ceramic from the system Y—Al—Mg—O, wherein up to 5 wt. % doping elements can he contained.
Components according to one of the preceding points, the substrate and die functional layer being connected to each other by means of an adhesion promotor.
Components according to one o preceding points, the adhesion promotor being an adhesive.
Components according to one of the preceding points, the adhesion promotor being a transparent adhesive.
Components according to one of the preceding points, the adhesion promotor being a transparent adhesive whose refractive index lies between the refractive index of the substrate and of the functional layer.
Components according to one of the preceding points, the adhesion promotor being a transparent adhesive whose refractive index is very similar to the refractive index of the functional layer, so that no perceivable phase transition or no perceivable boundary surface is produced for the intended use.

The present invention further comprises:
The use of the components according to one of the preceding points as surface, particularly a transparent surface, subjected to wear, for example as a scanner surface of cash register systems, surfaces of blasting cabinets, floor coverings, watch glasses or stairs.
The use of the components according to one of the preceding points in optical components, particularly for displays of mobile phones, tablets or computers in general.

1. Component with functional surface.

2. Component according to claim 1, characterized in that the component comprises a substrate and a polycrystalline functional layer, the functional layer comprising the functional surface.

3. Component according to claim 2, characterized in that the polycrystalline functional layer comprises a ceramic.

4. Component according to one of claim 2, characterized in that the substrate comprises a plastic, a glass, a glass ceramic or a ceramic or a composite material or a flexible material.

5. Component according to claim 1, characterized in that the functional layer has a thickness of less than 2 mm, preferably less than 0.5 mm and especially preferably Jess than 100 μm.

6. Component according to claim 1, characterized in that the substrate and/or the functional layer is transparent.

7. Component according to claim 1, characterized in that the functional layer is mechanically and/or chemically and/or thermally stable.

8. Component according to claim 1, characterized in that the functional layer has an optical function, particularly an antireflective effect and/or a filter effect.

9. Component according to claim 1 characterized in that the functional layer has a scratch-resistant and/or an anti-fog effect.

10. Component according to claim 1, characterized in that the substrate and the functional layer are connected to each other by means of an adhesion promoter.

11. Component according to claim 10, characterized in that the adhesion promoter is transparent and has a refractive index which lies between the refractive index of the substrate and of the functional layer, or a transparent adhesion promoter which has the same refractive index as the functional layer.

12. Component according to claim 1, characterized in that the functional layer is polished only on one side which is facing away from the substrate.

13. Component according claim 1, characterized in that the functional layer comprises a transparent ceramic, particularly an Al—Mg spinel, an Al₂O₃, an AlON, an SiAlON, ZrO₂ or a mixed oxide ceramic from the system Y—Al—Mg—O, wherein up to 5 wt. % doping elements can be contained.

14. Component according to claim 1, characterized in that the substrate and the functional layer are connected to each other by means of an adhesion promotor.

15. Component according to claim 1 characterized in that the adhesion promotor is an adhesive.

16. Component according to claim 1 characterized in that the adhesion promoter is a transparent adhesive.

17. Component according to claim 1, characterized in that the adhesion promoter is a transparent adhesive whose refractive index lies between the refractive index of the substrate and of the functional layer.

18. Component according to claim 1, characterized in that the adhesion promoter is a transparent adhesive whose refractive index is very similar to the refractive index of the functional layer, so that no perceivable phase transition or no perceivable boundary surface is produced for the intended use.

19. Use of a component according to claim 1 as a surface, particularly a transparent surface, which is subjected to wear, for example as a scanner surface of cash register systems, surfaces of blasting cabinets, floor coverings, watch glasses or stairs.

20. Use of a component according to claim 1 in optical components, particularly for displays of mobile phones, tablets or computers in general.
